(19) United States
(12) Patent Application Publication
(10) Pub. No.: US 2009/0272296 A1
(43) Pub. Date: Nov. 5, 2009

(54) Process for the Preparation of Products of High Early Strength Comprising Hydraulic Binders

(75) Inventors: Christoph Tontrup, Alzenau (DE); Wolfgang Lortz, Wachtersbach (DE); Kai Schumacher, Hofheim (DE); Christian Hübsch, Gmund (DE); Philippü Wieland, München (DE); Harald Grassl, Königssee (DE); Kerstin Becher, Waldhausen (DE); Stefanie Scheul, Trostberg (DE); Eva Jetzlsperger, Unterneukirchen (DE)

Correspondence Address: CURATOLO SIDOTI CO., LPA, 24500 CENTER RIDGE ROAD, SUITE 280, CLEVELAND, OH, 44145, US

(73) Assignee: Construction Research & Technology GmbH, Trostberg (DE)

(21) Appl. No.: 12/298,425

(22) PCT Filed: Apr. 5, 2007
(86) PCT No.: PCT/EP2007/053378

§ 371 Date: Jul. 7, 2009

(30) Foreign Application Priority Data
May 5, 2006 (DE) 102006020876.5

(51) Int. Cl. C09C 1/36

(52) U.S. Cl. 106/436

(57) ABSTRACT

A process for the preparation of products of high early strength comprising hydraulic binders, in which a hydraulic binder, water and 0.1 to 5% by weight, based on the hydraulic binder, of a finely divided titanium dioxide are mixed with agitation and in any desired sequence.

The invention relates to a process for increasing the early strength of products comprising hydraulic binders.

It is known to utilize the photocatalytic properties of titanium dioxide in cement mixtures.

In WO 98/05601, titanium dioxide is used to obtain color and brilliance from special concretes. It is especially mentioned that the compressive strength of concretes is not influenced by the titanium dioxide.

In WO 01/00541, a similar situation is disclosed, it being mentioned that the properties of the concretes obtained are not influenced.

In JP 2000117117, a mixture is disclosed which contains 100 parts by weight of cement and 10 to 150 parts by weight of titanium dioxide.

In GB-A-849175, a coating composition for concrete is disclosed, which consists of white cement and up to 3% by weight of titanium dioxide.

In summary, it can be said that in the prior art titanium dioxide is disclosed only as a photocatalytically active substance in cement mixtures.

It has now surprisingly been found that the early strength of products comprising hydraulic binders can be increased in the presence of titanium dioxide.

The invention therefore relates to a process for the preparation of products of high early strength comprising hydraulic binders, in which a hydraulic binder, water and 0.1 to 5% by weight, based on the hydraulic binder, of a finely divided titanium dioxide are mixed with agitation and in any desired sequence.

Contents of titanium dioxide of more than 5% by weight as a rule lead to a poorer workability of the still unhardened preparation comprising hydraulic binders (e.g. low extent of spread of the fresh concrete), with contents of less than 0.1% by weight the early strength is only insignificantly increased.

Preferably, the content of titanium dioxide is 0.1 to 2% by weight, a content of 0.25 to 1% by weight being particularly preferred.

A product having high early strength comprising hydraulic binders is here to be understood as meaning a product which at any desired point in time in the first 48 hours of hardening of the product reaches strengths which are at least 30% higher than the reference value of a product without titanium dioxide.

The products according to the invention comprising hydraulic binders are hardened products.

In the process according to the invention, aggregates can also be added. Aggregates are inert substances which consist of unbroken or broken particles (e.g. stones, gravel), of natural (e.g. sand) or artificial mineral substances.

Accordingly, the products comprising hydraulic binders include both the hydraulic binder pastes (i.e. hydraulic binder and water without aggregates) and conglomerates (i.e. mixtures of hydraulic binder, aggregates and water).

Examples of conglomerates are hydraulic mortars (mixture of hydraulic binder, water and fine aggregates) and concretes (mixture of hydraulic binder, water, coarse and fine aggregates).

Examples of products comprising hydraulic binders which can be mentioned are concrete finished parts (e.g. connecting pieces, trusses, slabs, beams, bracing supports, wall plates, facade plates) and concrete goods (e.g. pipes, paving stones).

A hydraulic binder is to be understood as meaning a binder which hardens spontaneously with added water. These are, for example, cement and hydraulic limes.

Finely divided titanium dioxide is to be understood as meaning one which has a BET surface area of 20 to 400 m²/g. Preferably, a titanium dioxide can be employed which has a BET surface area of 40 to 120 m²/g.

It has further proven advantageous to employ a titanium dioxide which is present in the form of aggregated particles.

Particles of this type can be prepared, for example, by flame oxidation or flame hydrolysis. Here, oxidizable and/or hydrolyzable starting substances are as a rule oxidized or hydrolyzed in a hydrogen-oxygen flame. Suitable starting substances are organic and inorganic substances. On account of its good processability, for example, titanium tetrachloride is particularly suitable. The particles of the titanium dioxide powder thus obtained are to the greatest extent pore-free and have free hydroxyl groups on the surface.

A highly suitable, commercially obtainable titanium dioxide powder is, for example, AEROXIDE® TiO₂ P25, Degussa, having a BET surface area of 50±15 m²/g. Furthermore, the titanium dioxides having a very narrow distribution of the primary particle diameters disclosed in WO 2005/054136 are advantageously used.

It is also possible to use mixed oxide powders which, in addition to titanium dioxide, contain a further metal oxide as a main constituent. These can be titanium/silicon (for example from DE-A-4235996), titanium/aluminum (for example from the German patent application having the application number 102004062104.7 of Dec. 23, 2004) or titanium/zirconium mixed oxide powder, for example from the German patent application having the application number 102004061702.3 of Dec. 22, 2004 or doped titanium dioxide powders as disclosed in EP-A-1138632.

The titanium dioxide or the titanium mixed oxide powders can also be employed in surface-modified form. Preferably, the following silanes, individually or as a mixture, can be employed for this:

organosilanes (RO)₃Si(CₙH₂ₙ₊₁) and (RO)₃Si(CₙH₂ₙ₋₁) with R=alkyl, such as methyl, ethyl, n-propyl, i-propyl, butyl and n=1-20,
organosilanes R′ₓ(RO)_{y}Si(CₙH₂ₙ₊₁) and R′ₓ(RO)_{y}Si(CₙH₂₋₁) with R=alkyl, such as methyl, ethyl, n-propyl, i-propyl, butyl;
R′=alkyl, such as methyl, ethyl, n-propyl, i-propyl, butyl;
R′=cycloalkyl; n=1-20; x+y=3, x=1, 2; y=1, 2,
haloorganosilanes X₃Si(CₙH₂ₙ₊₁) and X₃Si(CₙH₂ₙ₋₁) with X=Cl, Br; n=1-20,
haloorganosilanes X₂(R′)Si(CₙH₂ₙ₊₁) and X₂(R′)Si(CₙH₂ₙ₋₁) with X=Cl, Br, R′=alkyl, such as methyl, ethyl, n-propyl, i-propyl, butyl-; R′=cycloalkyl; n=1-20,
haloorganosilanes X(R′)₂Si(CₙH₂ₙ₊₁) and X(R′)₂Si(CₙH₂ₙ₋₁) with X=Cl, Br; R′=alkyl, such as methyl-, ethyl-, n-propyl-, i-propyl-, butyl-; R′=cycloalkyl; n=1-20,
organosilanes (RO)₃Si(CH₂)ₘ—R′ with R=alkyl, such as methyl-, ethyl-, propyl-; m=0, 1-20; R′=methyl, aryl such as —C₆H₅, substituted phenyl radicals, C₄F₉, OCF₂—CHF—CF₃, C₆F₁₃, OCF₂CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO—(CH₂)₅, NH—COO—CH₃, NH—COO—CH₂—CH₃, NH—(CH2)₃Si(OR)₃, Sₓ—(CH₂)₃Si(OR)₃, SH, NR′R″R′″ where R′=alkyl, aryl; R″═H, alkyl, aryl; R′″═H, alkyl, aryl, benzyl, C₂H₄NR′″ R′″″ where R″″═H, alkyl and R′″″═H, alkyl,
organosilanes (R″)ₓ(RO)_{y}Si(CH₂)ₘ—R′
with R″=alkyl, x+y=3; cycloalkyl, x=1, 2, y=1, 2; m=0, 1 to 20; R′=methyl, aryl, such as C₆H₅, substituted phenyl radicals, C₄F₉, OCF₂—CHF—CF₃, C₆F₁₃, OCF₂CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO—(CH₂)₅, NH—COO—CH₃, NH—COO—CH₂—CH₃, NH—(CH₂)₃Si(OR)₃, Sₓ—(CH₂)₃Si(OR)₃, SH, NR′R″R′″ with R′=alkyl, aryl; R″═H, alkyl, aryl; R′″═H, alkyl, aryl, benzyl, C₂H₄NR″″ R′″″ where R″″═H, alkyl and R′″″═H, alkyl,
haloorganosilanes X₃Si (CH₂)ₘ—R′
X=Cl, Br; m=0, 1-20; R′=methyl, aryl such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, —OOC(CH₃)C═CH₂, OCH₂—CH(O)CH₂, NH—CO—N—CO—(CH₂)₅, NH—COO—CH₃, —NH—COO—CH₂—CH₃, —NH—(CH₂)₃Si(OR)₃, —Sₓ—(CH₂)₃Si(OR), where R=methyl, ethyl, propyl, butyl and x=1 or 2, SH,
haloorganosilanes RX₂Si(CH₂)ₘR′
X=Cl, Br; m=0, 1-20; R′=methyl, aryl such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, —OOC(CH₃)C═CH₂, OCH₂—CH(O)CH₂, NH—CO—N—CO— (CH₂)₅, NH—COO—CH₃, —NH—COO—CH₂—CH₃, —NH— (CH₂)₃Si(OR)₃, —Sₓ—(CH₂)₃Si(OR), where R=methyl, ethyl, propyl, butyl and x=1 or 2, SH,
haloorganosilanes R₂XSiCH₂)ₘR′
X=Cl, Br; m=0, 1-20; R′=methyl, aryl such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO— (CH₂)₅, NH—COO—CH₃, —NH—COO—CH₂—CH₃, —NH— (CH₂)₃Si(OR)₃, —Sₓ—(CH₂)₃Si(OR)₃, where R=methyl, ethyl, propyl, butyl and x=1 or 2, SH,
silazanes R′R₂SiNHSiR₂R′ with R, R′=alkyl, vinyl, aryl,
cyclic polysiloxanes D3, D4, D5 where D3, D4 and D5 are understood as meaning cyclic polysiloxanes having 3, 4 or 5 units of the type —O—Si(CH₃)₂, e.g. octamethylcyclotetrasiloxane=D4

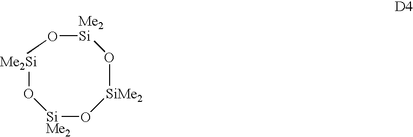

polysiloxanes or silicone oils of the type

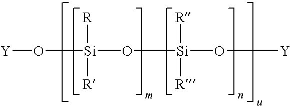

with
R=alkyl, aryl, (CH₂)ₙ—NH₂, H
R′=alkyl, aryl, (CH₂)ₙ—NH₂, H
R″=alkyl, aryl, (CH₂)ₙ—NH₂, H
R′″=alkyl, aryl, (CH₂)ₙ—NH₂, H
Y═CH₃, H, C_{z}H_{2z+1} where z=1-20,

### Si (CH₃)₃, Si (CH₃)₂H, Si(CH₃)₂OH, Si (CH₃)₂(OCH₃),

### Si (CH₃)₂(C_{z}H_{2z+1})

where

### R′ or R″ or R′″ (CH₂)—NH₂ and

z=1-20,
m=0,1,2,3, . . . ∞,

n=0,1,2,3, . . . ∞,

u=0,1,2,3, . . . ∞,

Preferably, as surface-modifying agents the following substances can be employed: octyltrimethoxysilane, octyltriethoxysilane, hexamethyldisilazane, 3-methacryloxypropyltrimethoxysilane, 3-methacryloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nonafluorohexyl-trimethoxysilane, tridecafluorooctyltrimethoxysilane, tridecafluorooctyltriethoxysilane, aminopropyltriethoxysilane.

Particularly preferably, octyltrimethoxysilane, octyltriethoxysilane and dimethylpolysiloxanes can be employed.

A suitable surface-modified titanium dioxide powder is, for example, AEROXIDE® TiO₂ T805, Degussa having a BET surface area of 45±10 m²/g and a carbon content of 2.7-3.7% by weight.

Titanium dioxide can also be employed in the form of a dispersion. Advantageously, highly filled, aqueous dispersions having a small particle size are concerned here. Titanium dioxide dispersions having a titanium dioxide content of at least 20% by weight, very particularly preferably of at least 30% by weight, based on the dispersion, are particularly preferred. Furthermore, those dispersions are preferred in which the titanium dioxide particles have a mean aggregate diameter in the dispersion of not more than 2 μm. Particularly preferably, dispersions having a mean aggregate diameter of less than 300 nm can be employed. The pH of the dispersion is preferentially 2 to 4 or 9 to 13. However, dispersions in the range from 4 to 9 can also be employed. The pHs are adjusted by addition of acids or bases. The dispersion can furthermore contain additives which are effective against sedimentation and reagglomeration. Acids, bases and/or additives should be chosen such that no adverse interactions occur with the constituents of the hydraulic binder. As a rule, the liquid phase of the dispersion is aqueous.

By the use of titanium dioxide dispersion, dust pollution by powder is avoided and the meterability is simplified.

Table 1 shows suitable dispersions by way of example. The median values of the particle size distribution (d₅₀) can be determined, for example, using a measuring apparatus which analyzes the dynamic light scattering (in the present case LB-500 from Horiba).

TABLE 1
Titanium dioxide dispersions

| BET | Content | | | |
|---|---|---|---|---|
| surface | of TiO₂ | | | |
| area | % by | d₅₀ | | |
| m²/g | weight | μm | pH | Stabilization |
| 50 | 40 | <2 | 2-4 | HNO₃ |
| 90 | 30 | <1.5 | 2-4 | HNO₃ |
| 90 | 30 | <0.05 | 2-4 | HNO₃ |
| 50 | 40 | <0.10 | 2-4 | HNO₃ |
| 50 | 30 | <0.3 | 10-13 | NaOH |
| 90 | 30 | <0.2 | 10-13 | NaOH |

Commercially obtainable titanium dioxide dispersions are, for example, VP Disp W 740×(40% by weight TiO₂, d₅₀<0.2 μm, pH 6-9) and VP Disp W 2730×(30% by weight TiO₂, d₅₀<0.1 μm, pH 6-8).

A flow agent can furthermore be employed in the process according to the invention. Preferably, one is selected from the group consisting of the ligninsulfonates, naphthalenesulfonates, melaminesulfonates, vinyl copolymers and/or polycarboxylates. Particularly good results are obtained using polycarboxylates.

### EXAMPLES

### Types of Titanium Dioxide Employed

a) AEROXIDE® TiO₂ P25 (Degussa AG), powder having 50±15 m²/g BET surface area,=1.5% by weight loss on drying and pH 3.5-4.5.
b) TiO₂-2: titanium dioxide powder according to WO 2005/054136, Example A7, BET surface area 91 m²/g.
c) pigmentary titanium dioxide powder: TiPure® R 706, DuPont, BET surface area<10 m²/g, content of titanium dioxide 93% by weight.
d) silicon-titanium mixed oxide: according to DE-A-102004001520, Example 12, powder having 43 m²/g BET surface area, 49% by weight titanium dioxide, 51% by weight silicon dioxide.
e) TiO₂ dispersion 1 (aqueous): TiO₂ BET surface area: 90 m²/g, TiO₂ content 30% by weight, d₅₀<0.05 μm, pH=2-4, stabilization HNO₃.
f) TiO₂ dispersion 2 (aqueous): TiO₂ BET surface area: 50 m²/g, TiO₂ content 30% by weight, d₅₀<0.30 μm, pH=10-13, stabilization NaOH.

### Example 1

A conventional concrete having a water-cement value of 0.4 is prepared using 370 kg of cement (CEM I 52.5 from Schwenk Zement KG) and the compressive strength is measured on test pieces of dimensions 15×15×15 cm after 6 h according to DIN EN 12390-3. In comparison to this, 0.5% by weight, based on the cement, of the titanium dioxides and titanium-silicon dioxide mixed oxides listed in Table 2 are added to this cement, and the compressive strength is likewise determined after 6 h.

TABLE 2
Influence of various types of titanium dioxide on the early strength

| | | Compressive | Increase in |
|---|---|---|---|
| | | strength | compressive |
| | | after 6 h | strength |
| Example | Titanium dioxide | N/mm² | % |
| 1a (comp.) | Without titanium | 3.56 | — |
| | dioxide | | |
| 1b (comp.) | Pigmentary TiO₂ | 3.64 | 2 |
| 1c | AEROXIDE ® TiO₂ P25 | 9.04 | 153 |
| 1d | TiO₂-2 | 11.05 | 210 |
| 1e | Si—Ti mixed oxide | 7.15 | 100 |

*) based on cement;

Table 2 shows that a very considerable increase in the early strength can be achieved by the use of finely divided titanium dioxide. This turns out to be higher, the higher the specific surface area of the titanium dioxide. By the use of low-surface area, pigmentary titanium dioxide, however, only a slight increase in the early strength is achieved. The early strength can also be markedly increased by the use of finely divided titanium dioxide-containing mixed oxides.

### Example 2

A conventional concrete having a water-cement value of 0.42 is prepared using 370 kg of cement (CEM I 52.5 from Schwenk Zement KG) and the compressive strength is measured on test articles of dimensions 15×15×15 cm after 6 h according to DIN EN 12390-3. In comparison to this, the amounts of pyrogenic titanium dioxide (Aeroxide® TiO₂ P25 from Degussa AG) listed in Table 3 are added to this concrete and the compressive strength is likewise determined after 6 h.

TABLE 3
Influence of the amount of titanium dioxide on the early strength

| | Content | Compressive | Increase in |
|---|---|---|---|
| | of TiO₂ | strength | compressive |
| | % by | after 6 h | strength |
| Example | weight*⁾ | N/mm² | % |
| 2a (comp.) | 0 | 1.86 | — |
| 2c | 0.25 | 2.42 | 30 |
| 2d | 0.5 | 3.14 | 68 |
| 2e | 1.0 | 4.03 | 117 |

*⁾based on cement;

Table 3 shows that the increase in the early strength is associated with the content of titanium dioxide. A significant increase in the early strength can be observed from a content of titanium dioxide of 0.25% by weight with increase in the early strength by 30% compared to the example without titanium dioxide.

### Example 3

A standard mortar according to DIN EN 196 is prepared using a cement (CEM I 52.5 Schwenk Zement KG). After this, the amount of titanium dioxide indicated in Table 4 is in each case added to the mortar in the form of a dispersion. Different amounts of a commercially customary superplasticizers based on polycarboxylate are added to the mortar mixture es at a constant water/cement ratio of 0.4 in order to guarantee comparable workability for all mortar mixtures. After 8 h, the compressive strength is tested on prisms of size 4×4×16 cm according to DIN 1164. The results are summarized in Table 4.

TABLE 4
Early strength when using titanium dioxide dispersions

| | Content of | Content of | | |
|---|---|---|---|---|
| | TiO₂ | super- | | Increase in |
| | dispersion | plasticizers | Compressive | compressive |
| | % by | % by | strength 8 h | strength |
| Example | weight*⁾ | weight*⁾ | N/mm² | % |
| 3a (comp.) | Without | 0.163 | 8.64 | — |
| 3b^{$)} | 1.25 | 0.174 | 14.29 | 65 |
| 3c^{&)} | 1.67 | 0.174 | 16.25 | 88 |

^{$)}titanium dioxide dispersion 1;
^{&)}titanium dioxide dispersion 2;
*⁾based on cement;

Table 4 shows that even with preparations which contain titanium dioxide dispersions, a marked increase in the early strength can be achieved.

1. A process for the preparation of products of high early strength comprising hydraulic binders, wherein a hydraulic binder, water and 0.1 to 5% by weight, based on the hydraulic binder, of a finely divided titanium dioxide are mixed with agitation and in any desired sequence.

2. The process as claimed in claim 1, wherein the BET surface area of particles of the titanium dioxide is 40 to 120 m²/g.

3. The process as claimed in claim 2, wherein the titanium dioxide is added in the form of a dispersion.

4. The process as claimed in claim 1, wherein the titanium dioxide is added in the form of a dispersion.
